(19) United States
(12) Patent Application Publication
(10) Pub. No.: US 2011/0199445 A1
(43) Pub. Date: Aug. 18, 2011

(54) LIQUID EJECTING HEAD

(75) Inventor: Takashi ITO, Nagoya-shi (JP)

(73) Assignee: BROTHER KOGYO KABUSHIKI KAISHA, Nagoya-shi (JP)

(21) Appl. No.: 13/028,165

(22) Filed: Feb. 15, 2011

(30) Foreign Application Priority Data
Feb. 15, 2010 (JP) 2010-029800

(51) Int. Cl. B41J 2/175

(52) U.S. Cl. 347/93

(57) ABSTRACT

A liquid ejecting head having a forward passage system extending from a liquid inlet opening to liquid-droplet ejecting nozzles, a first filter and a second filter disposed in series with each other in the forward passage system to capture foreign matters in the liquid, such that the first filter is located upstream of the second filer as seen in a direction of flow of the liquid through the forward passage system, a first return passage system extending from one of opposite surfaces of the first filter which is on an upstream side as seen in the direction of flow of the liquid, to a first liquid outlet opening different from the inlet opening, and a second return passage system extending from one of opposite surfaces of the second filter which is on an upstream side as seen in the direction of flow of the liquid, to a second liquid outlet opening different from the first outlet opening.

### CROSS REFERENCE TO RELATED APPLICATION

The present application claims the priority from Japanese Patent Applications No. 2010-029800 filed Feb. 15, 2010, the disclosure of which is herein incorporated by reference in its entirety.

### BACKGROUND OF THE INVENTION

1. Field of the Invention

The present invention relates to a liquid ejecting head configured to eject droplets of a liquid such as an ink.

2. Description of Related Art

An ink-jet head known as an example of a liquid ejecting head has an ink inlet through which an ink is introduced from an ink tank, a multiplicity of ink-ejecting nozzles open in an ink-ejecting surface to eject droplets of the ink, and ink passages extending from the ink inlet to the ink-ejecting nozzles. To capture foreign matters (such as air bubbles and dust) contained in the ink within the ink-jet head, that is, to filter the ink, it is known to provide a filter one of the ink passages. By this filter, the foreign matters in the ink are captured before the ink flows to the ink-ejecting nozzles, to prevent dwelling of the foreign matters near the ink-ejecting nozzles, and consequent deterioration of the ink-ejecting function of the ink-jet head.

### SUMMARY OF THE INVENTION

There has been a need to increase the printing efficiency of the ink-jet head. To satisfy this need, it is necessary not only to increase the number of the ink-ejecting nozzles, but also to improve the efficiency of capturing the foreign matters within the ink passages. Where only one filter is disposed within the ink-jet head, however, the improvement of the efficiency of capturing the foreign matters by reducing the mesh size (diameter) of the filter is limited.

To improve the efficiency of capturing the foreign matters, it is considered to increase the number of the filters disposed in the ink passages, for example, to dispose one filter in an upstream one of the ink passages and another filter in a downstream one of the ink passages. However, the provision of the two or more filters may cause various drawbacks, such as a need of discharging the foreign matters deposited on the filters, out of the ink passages, in order to prevent an increase of the resistance of ink flows through the ink passages. To overcome the drawbacks, it is necessary to perform purging operations for forcibly introducing the ink from the ink tank into the flow passages to discharge the foreign matters deposited on the filters, together with the ink. However, the purging operations usually require a relatively large amount of consumption of the ink.

The present invention was made in view of the background art described above. It is therefore an object of the present invention to provide a liquid ejecting head which is configured to satisfy both the need of improving the efficiency of capturing the foreign matters within liquid flow passages, and the need of reducing the amount of consumption of the liquid required for discharging the foreign matters deposited on each filter.

The object indicated above can be achieved according to the principle of this invention, which provides a liquid ejecting head comprising: defining a forward passage system extending from an inlet opening to which a liquid is supplied from a liquid supply source, to a plurality of liquid-droplet ejecting nozzles; a first filter and at least one second filter disposed in series with each other in the forward passage system to capture foreign matters contained in the liquid, such that the first filter is located upstream of the at least one second filer as seen in a direction of flow of the liquid through the forward passage system; a first return passage system extending from one of opposite surfaces of the first filter which is on an upstream side as seen in the above-indicated direction of flow of the liquid, to a first outlet opening from which the liquid is discharged and which is different from the inlet opening; and defining a second return passage system extending from one of opposite surfaces of the at least one second filter which is on an upstream side as seen in the above-indicated direction of flow of the liquid, to a second outlet opening from which the liquid is discharged and which is different from the first outlet opening.

### BRIEF DESCRIPTION OF THE DRAWINGS

The above and other objects, features, advantages and technical and industrial significance of the present invention will be better understood by reading the following detailed description of a preferred embodiment of the present invention, when considered in connection with the accompanying drawings, in which:

FIG. 1 is a schematic side elevational view of an ink-jet type printer including an ink-jet head as a liquid ejecting head constructed according to a first embodiment of this invention;

FIG. 2 is a side elevational view of the ink-jet head of FIG. 1;

FIG. 3A is an exploded perspective of the ink-jet head of FIG. 1, and FIG. 3B is a cross sectional view taken along line B-B of FIG. 3A;

FIG. 4 is a plan view of a passage unit of the ink-jet head of FIG. 1;

FIGS. 5A, 5B and 5C are views indicating ink flows through the ink-jet head of FIG. 1 during a printing operation of the ink-jet head, wherein FIG. 5A is a fragmentary cross sectional view of a first chamber of a filter unit, and FIG. 5B is a fragmentary cross sectional view of a second chamber of the filter unit, while FIG. 5C is a fragmentary exploded perspective view of the filter unit and a reservoir unit;

FIGS. 6A, 6B and 6C are views indicating ink flows through the ink-jet head of FIG. 1 during a nozzle purging operation of the ink-jet head, wherein FIG. 6A is a fragmentary cross sectional view of the second chamber of the filter unit, and FIG. 6B is a fragmentary cross sectional view of the first chamber of the filter unit, while FIG. 6C is a fragmentary exploded perspective view of the filter unit and the reservoir unit;

FIGS. 7A and 7B are views indicating ink flows through the ink-jet head of FIG. 1 during a circulation purging operation of the ink-jet head, wherein FIG. 7A is a fragmentary cross sectional view of the second chamber of the filter unit, and FIG. 6B is a fragmentary cross sectional view of the first chamber of the filter unit; and

FIGS. 8A, 8B and 8C are views indicating ink flows through the ink-jet head of FIG. 1 during an inter-filter purging operation of the ink-jet head, wherein FIG. 8A is a fragmentary cross sectional view of the second chamber of the filter unit, and FIG. 8B is a fragmentary cross sectional view of the first chamber of the filter unit, while FIG. 8C is a fragmentary exploded perspective view of the filter unit and the reservoir unit.

### DETAILED DESCRIPTION OF THE PREFERRED EMBODIMENTS

The preferred embodiment of this invention will be described by reference to the accompanying drawings.

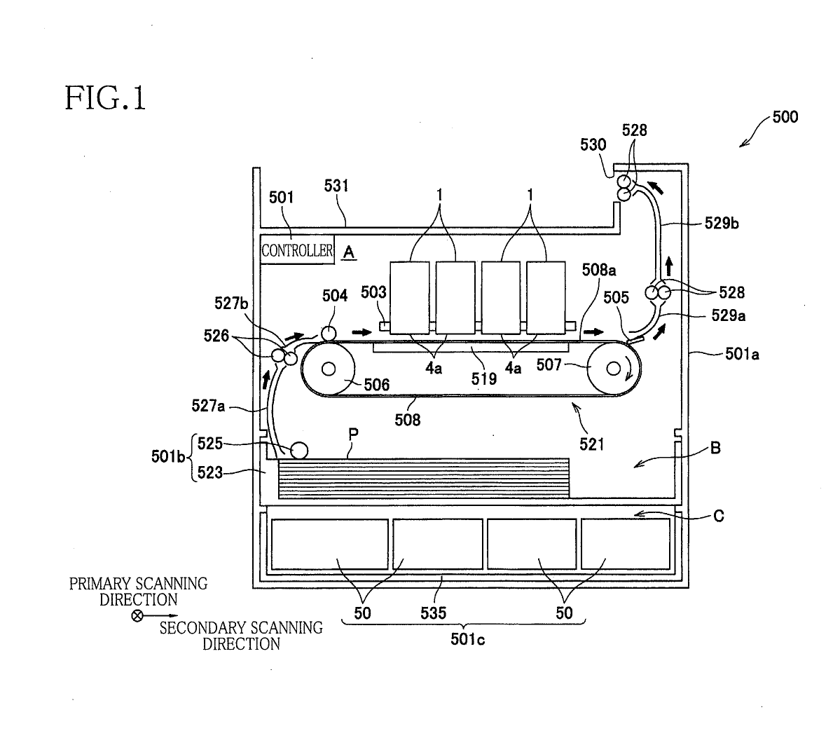

Referring first to the schematic side elevational view of FIG. 1, there is shown a printer 500 of an ink-jet type including four ink-jet heads 1 each constructed as a liquid ejecting head constructed according to the preferred embodiment of the present invention. Each of the ink-jet heads 1 is a so-called “line printing head” disposed so as to extend in one direction (direction perpendicular to the plane of the view of FIG. 1). That is, each ink-jet head 1 has its longitudinal direction that is a primary scanning direction, which is perpendicular to a secondary scanning direction in which the four ink-jet heads 1 are arranged in the ink-jet printer 500 of the line printing type.

The printer 500 has a housing 501a in the form of a generally rectangular parallelepiped having a top wall that serves as a sheet receiver 531. The housing 501a has three functional spaces A, B and C arranged in the order of description in the downward direction. A sheet transfer path along which a sheet of paper P is fed is formed through the functional spaces A and B and leads to the sheet receiver 531. In the functional space A, printing operations of the ink-jet heads 1 to print images on the paper sheet P are performed. In the functional space B, the paper sheets P are supplied one after another from a sheet supply tray 523 of a sheet supply unit 501b. In the functional space C, four ink cartridges (main tanks) 50 are disposed as ink supply sources.

In the functional space A, there are disposed the above-described four ink-jet heads 1, a sheet transfer unit 521, and sheet guide devices for guiding the paper sheet P. In an upper part of the functional space A, there is disposed a controller 501 for controlling operations of various devices of the printer 500.

Each ink-jet head 1 has a housing in the form of a generally rectangular parallelepiped the longitudinal direction of which is parallel to the primary scanning direction. The housing 501a has a head frame 503 supporting the four ink-jet heads 1 such that the four ink-jet heads 1 are arranged at a predetermined pitch in the secondary scanning direction. The four ink-jet heads 1 are supplied with respective four colors of ink, namely, magenta, cyan, yellow and black inks, as described below, and are configured to eject droplets of the respective colors of ink from their lower surfaces (ink ejecting surfaces) 4a toward the paper sheet P. The construction of each ink-jet head 1 will be described in more detail.

The sheet transfer unit 521 includes two belt rollers 506, 507, an endless conveyor belt 508 connecting the two belt rollers 506, 507, a nip roller 504 disposed adjacent to the belt roller 506, a sheet separator plate 505 disposed adjacent to the belt roller 507, and a platen 519 disposed within the loop of the conveyor belt 508. The belt roller 507 is a drive roller rotated clockwise as seen in FIG. 1 by a belt drive motor (not shown) under the control of the controller 501. As a result of the clockwise rotation of the belt roller 507, the upper span of the conveyor belt 508 is moved rightwards as indicated by arrows in FIG. 1. The belt roller 506 is a driven roller rotated clockwise as the conveyor belt 508 is rotated by the belt roller 507. The nip roller 504 cooperates with the belt roller 506 to press the paper sheet P onto an outer surface 508a of the conveyor belt 508 as the paper sheet P is fed from an upstream sheet guide device (described below). The outer surface 508a is coated with a slightly adhesive silicone layer. The sheet separator plate 505 disposed adjacent to the belt roller 507 functions to separate the paper sheet P from the outer surface 508a, so that the paper sheet P is fed toward a downstream sheet guide device (described below). The platen 519 is disposed below and in opposition to the four ink-jet heads 1, and functions to support the upper span of the conveyor belt 508 on its inner surface, so that a suitable amount of gap required to permit desired image forming operations of the ink-jet heads 1 is maintained between the outer surface 508a and the ink ejecting surfaces 4a of the ink-jet heads 1.

The upstream and downstream sheet guide devices are disposed on the respective opposite sides of the sheet transfer unit 521. The upstream sheet guide device includes two guides 527a, 527b, and a pair of feed rollers 526, and functions to guide the paper sheet P from the above-indicated sheet supply unit 501b to the sheet transfer unit 521. The downstream sheet guide device includes two guides 529a, 529b, and a pair of feed roller 528, and functions to guide the paper sheet P from the sheet transfer unit 521 to the sheet receiver 531. One of the two feed rollers 526, and one of the two feed rollers 528 are driven by a sheet feed motor (not shown) under the control of the controller 501. The guides 527a, 527b, 529a, 529b are arranged to guide the paper sheet P to and from the pairs of rollers 526, 528.

In the functional space B, there is disposed the above-indicated sheet supply unit 501b such that the sheet supply unit 501b is removable from the housing 501a. The sheet supply unit 501b includes the above-indicated sheet supply tray 523 and a sheet supply roller 525. The sheet supply tray 23 is a box having an upper opening, and accommodates a stack of paper sheets P. The sheet supply roller 525 is driven by a sheet supply motor (not shown) under the control of the controller 501, to feed the uppermost paper sheet P of the stack toward the upstream sheet guide device.

In the functional spaces A and B, the sheet transfer path is formed so as to extend from the sheet supply unit 501b to the sheet receiver 531 through the sheet transfer unit 521. The sheet supply motor, sheet feed motor and belt drive motor described above are driven under the control of the controller 501 according to printing control commands, so that the uppermost paper sheet P is fed by the sheet supply roller 525 from the sheet supply tray 523, fed by the feed rollers 526 to the sheet transfer unit 521, and fed by the conveyor belt 508 under the ink ejecting surfaces 4a of the ink-jet heads 1 in the secondary scanning direction while the ink droplets are ejected from the ink ejecting surfaces 4a, whereby the desired color images are printed on the paper sheet P. Subsequently, the paper sheet P is separated by the sheet separator plate 505 from the outer surface 508a of the conveyor belt 508, and is fed upwards by the pair of feed rollers 528 while the paper sheet P is guided by the guides 529a, 529b, and is ejected onto the sheet receiver 531.

The secondary scanning direction is a horizontal direction parallel to the direction of feeding of the paper sheet p by the sheet transfer unit 521, while the primary scanning direction is a horizontal direction perpendicular to the secondary scanning direction.

In the functional space C, there is disposed an ink unit 501c such that the ink unit 501c is removable from the housing 501a. The ink unit 501c includes a tank tray 535, and the above-indicated four main tanks (ink cartridges) 50, which are respectively used for the four ink-jet heads 1 and are arranged in the tank tray 535 in the secondary scanning direction. The ink is supplied from each of the main tanks 50 through a tube to the corresponding ink-jet head 1.

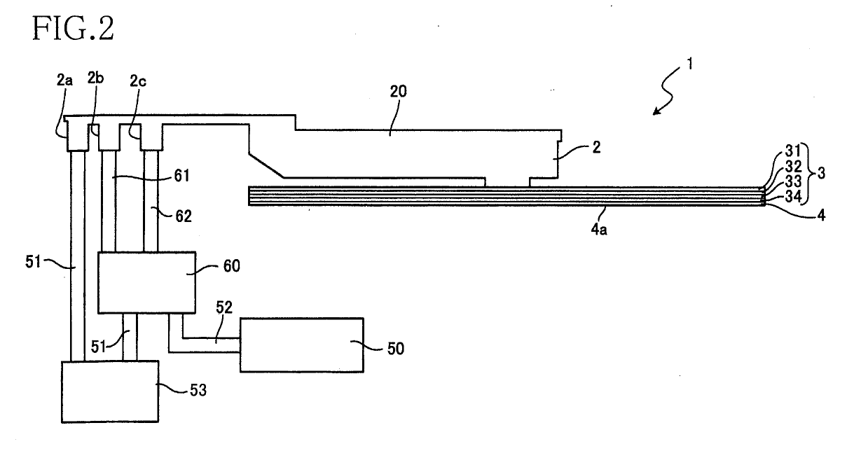

Referring nest to FIGS. 2-4, the construction of each ink-jet head 1 will be described. As shown in FIG. 2, the ink-jet head 1 includes a filter unit 2, a reservoir unit 3 and a passage unit 4, which are arranged in the order of description in the downward direction.

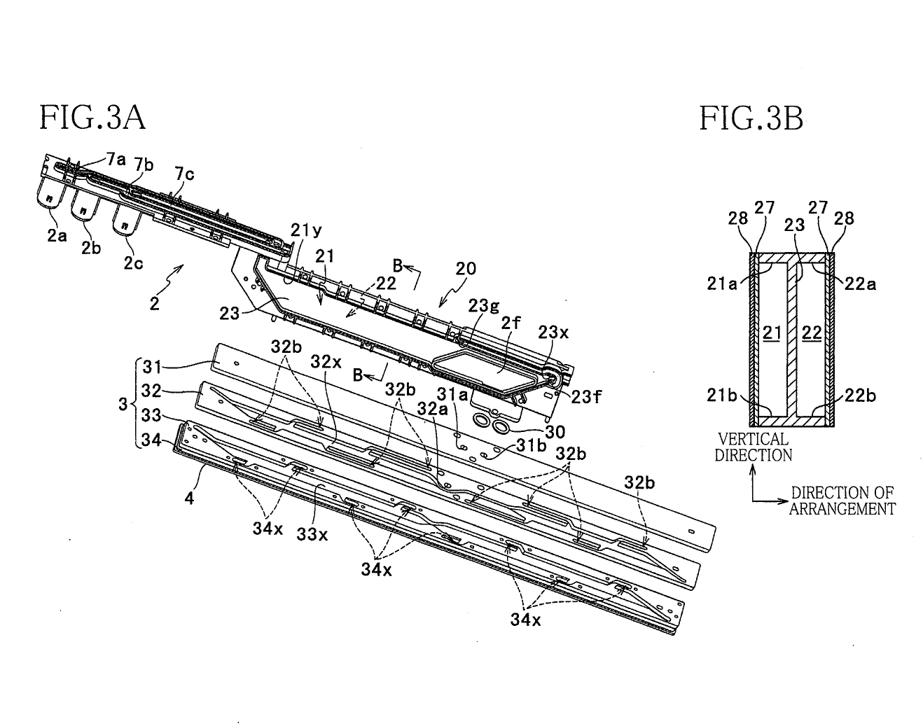

The filter unit 2 is a one-piece structure formed of a suitable material such as a synthetic resin, consisting of two planar portions connected together at their one ends so as to extend in one direction such that the planes of the two planar portions are perpendicular to each other, that is, parallel to the respective vertical and horizontal directions. One of the two planar portions is a base portion 20 provided with a first filter in the form of a filter 2f, while the other planar portion is a connector portion having three joints 2a, 2b and 2c in the form of sleeves, as shown in FIG. 3A. The joints 2a, 2b and 2c are disposed at one of the opposite longitudinal end portions of the connector portion, which is remote from the base portion 20. The joints 2a-2c extend downwards, for connection with respective elastic tubes 51, 61 and 62. As shown in FIG. 2, the filter unit 2 is connected to a pump 53 and an auxiliary tank 60 through the joints 2a-2c and elastic tubes 51, 61, 62. The pump 53 is connected to an intermediate portion of the elastic tube 51.

The main and auxiliary tanks 50, 60 serve as a liquid supply source, which store an ink of a color corresponding to the ink-jet head 1, and are held in communication with each other through an elastic tube 52. The main tanks (ink cartridges) 50 are removably installed in the housing 501a of the printer 500, as shown in FIG. 1, and supply the auxiliary tank 60 with the ink, as needed. The auxiliary tank 60 has a hole (not shown) open to the atmosphere, through which air bubbles contained in the ink are released into the atmosphere. The auxiliary tank 60 is disposed at a suitable position within the housing 501a. The pump 53, and valves connected to the elastic tubes 51, 61, 62 are controlled by the controller 501 (shown in FIG. 1) during a printing operation or purging operations of the ink-jet head 1, as described below in detail. During the printing operation, the ink is supplied from the auxiliary tank 62 to the filter unit 2 through the elastic tube 62, and then fed forwards to ink-ejecting nozzles (not shown) of the passage unit 4 through a forward ink passage system described below. During the purging operations, the pump 53 is operated to supply the ink from the auxiliary tank 60 to the filter unit 2 through the tube 51, for feeding the ink through the ink-jet head 1 through a forward ink passage system, and the ink is returned back to the auxiliary tank 60 through the tube 61 or 62, through a return ink passage system.

The construction of the filter unit 2 and flows of the ink during the printing and purging operations of the ink-jet head 1 will be described below in detail.

The reservoir unit 3 is a laminar passage-forming structure consisting of four rectangular metal plates 31, 32, 33 and 34 which have the same surface area as seen in the horizontal plane and which are bonded together. As shown in FIG. 3A, he reservoir unit 3 is fluid-tightly fixed to the filter unit 2 through two O-rings 30 formed of a rubber or other elastic material, and by means of suitable fixing means.

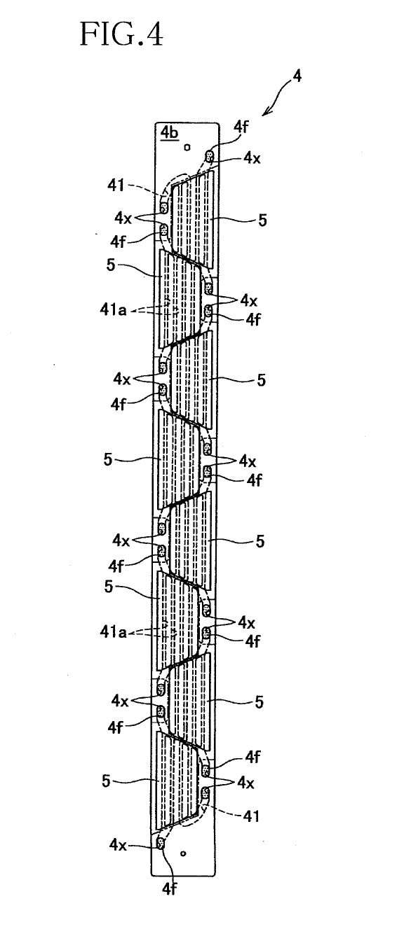

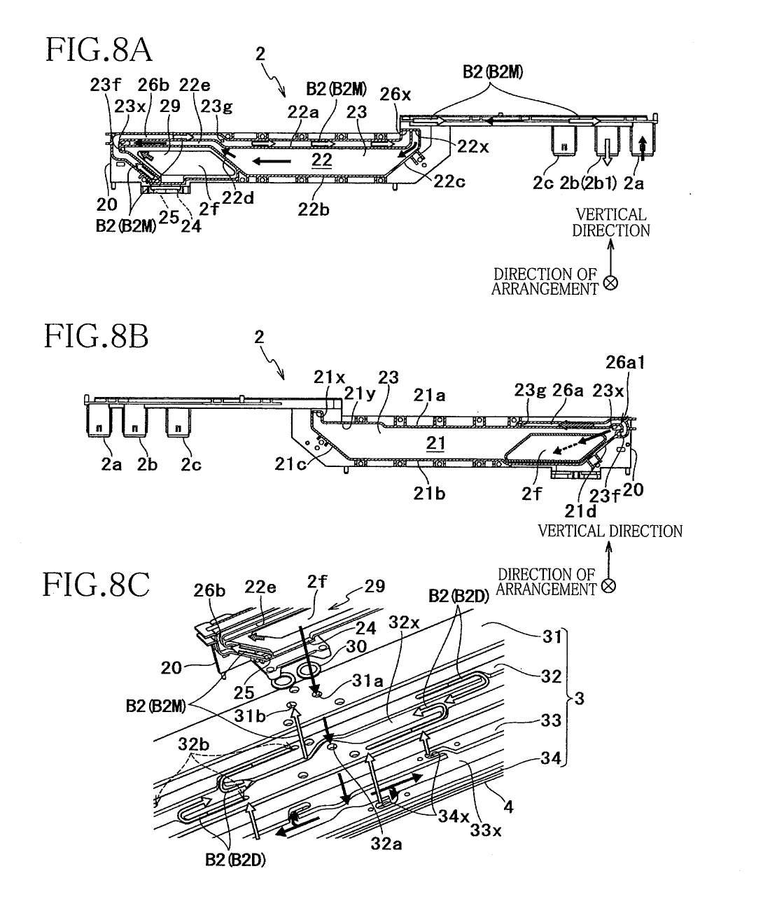

As also shown in FIG. 3A, each of the metal plates 31-34 of the reservoir unit 3 has through-holes and recesses for forming ink passages in the reservoir unit 3. Described more specifically, the uppermost metal plate 31 has two through-holes 31a and 31b, and the second metal plate 32 has a through-hole 32a communicating with the through-hole 31a, a recess 32x communicating with the through-hole 31b, and through-holes 32b formed in an end portion of each of branch grooves of the recess 32x. The through-hole 32a is held in communication with a reservoir 33x (described below), and the recess 32x is formed in the upper surface of the metal plate 32, so as to extend in the longitudinal direction of the ink-jet head 1, so that the ink containing the foreign matters flows through the recess 32x during an inter-filter purging operation of the ink-jet head 1, which will be described by reference to FIG. 8. The through-holes 32b respectively communicate with the end portions of branch passages of the reservoir 33x. The third metal plate 33 has the above-indicated reservoir 33x, which temporarily stores the ink. The reservoir 33x is formed through the thickness of the third metal plate 33, so as to extend in the longitudinal direction of the ink-jet head 1. The end portions of the branch passages of the reservoir 33x are held in communication with the through-holes 32b formed in the end portions of the branch grooves of the recess 32 in the second metal plate 32 superposed on the third metal plate 33, and are aligned with respective through-holes 4x (shown in FIG. 4) formed through the passage unit 4 located below the third metal plate 33. The reservoir 33x are closed at its upper opening by the lower surface of the second metal plate 32, and at its lower opening by the upper surface of the fourth metal plate 34, except in the end portions of the branch passages of the reservoir 33x. The fourth metal plate 34 has through-holes 34x in communication with the above-indicated through-holes 4x formed through the passage unit 4, and with the end portions of the branch passages of the reservoir 33x.

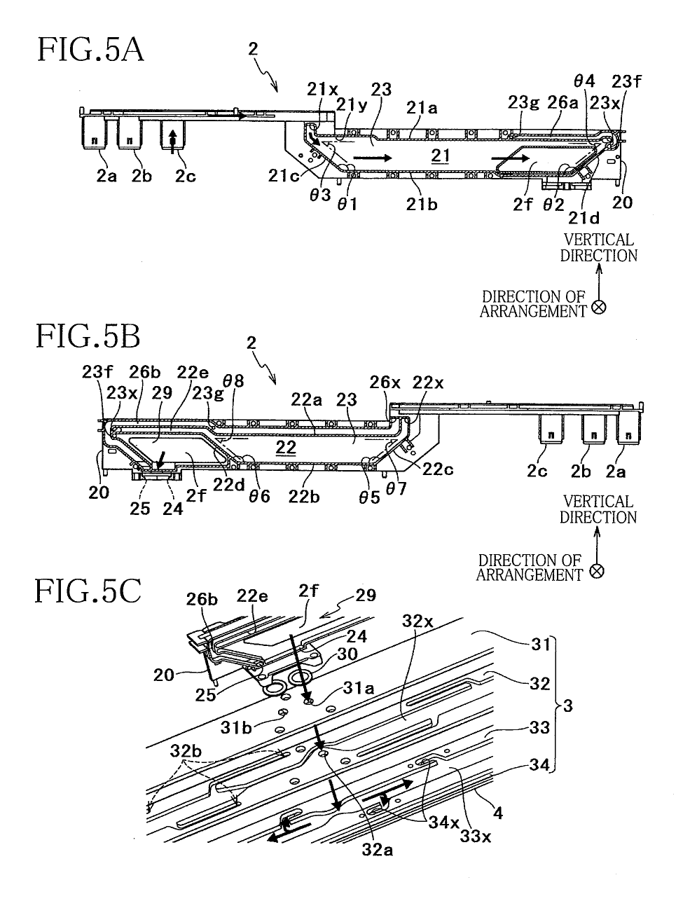

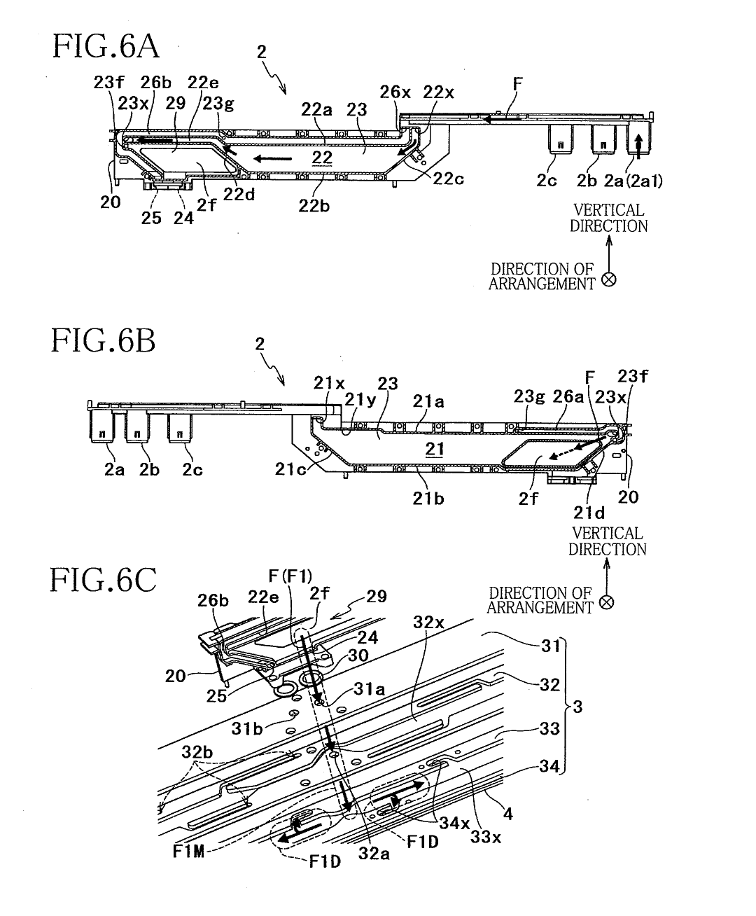

As described above, the reservoir unit 32 has two ink passage systems. During the printing operation (described below by reference to FIG. 5) and a nozzle purging operation (described below by reference to FIGS. 6A-6C) of the ink-jet head 1, the ink flows through one of the ink passage systems, that is, the ink flows from the filter unit 2 through the through-holes 31a, 32a into the reservoir 33x, more specifically, into the branch passages of the reservoir 33x, and flows into the through-holes 4x of the passage unit 4 through the through-holes 34x. During the inter-filter purging operation (described by reference to FIGS. 8A-8C) of the ink-jet head 1, the ink flows through the other ink passage system, that is, the ink fed into the reservoir 33x through the through-hole 32a flows from the branch passages of the reservoir 33x into the recess 32x through the through-holes 32b, and then into the filter unit 2 through the through-hole 31b.

As shown in FIG. 4, the passage unit 4 has eight piezoelectric actuator units 5 each having a trapezoidal shape, which are arranged in two rows in a zigzag fashion on its upper surface 4b. The through-holes 4x described above are formed in surface areas of the passage unit 4 outside the surface areas of the actuator units 5. In the surface areas of a lower surface 4a (shown in FIG. 2) of the passage unit 4 which correspond to the respective surface areas of the actuator unit 5, a multiplicity of ink ejecting nozzles (not shown) serving as liquid-droplet ejecting nozzles are open for ejecting the ink droplets. The passage unit 4 has main manifold passages 41 in communication with the through-holes 4x, auxiliary manifold passages 41a in communication with the main manifold passages 41, and individual ink passages for communication between the auxiliary manifold passages 41a and the ink-ejecting nozzles. As shown in FIG. 4, the main manifold passages 41 are held in communication with the through-holes 4x.

The lower surface of the lowermost metal plate 34 of the reservoir unit 3 has recessed and raised portions The recessed portions cooperate with the upper surface 4b to define spaces in which the respective actuator units 5 are fixed to the upper surface 4b. The lower surface of the metal plate 34 cooperates with a flexible printed circuit FPC) covering the actuator units 5, to define a small amount of gap. The through-holes 34x in communication with the reservoir 33x are formed through the raised portions formed on the lower surface of the metal plate 34, such that the through-holes 34x are open in the top surfaces of the raised portions. The lower surface of the metal plate 34 is bonded at these top surfaces to the upper surface 4b of the passage unit 4.

Referring to FIGS. 3A and 3B and FIGS. 5A-5C, the construction of the filter unit 2 will be described in detail.

As shown in FIG. 3A, a connecting portion of the filter unit 2 has three connecting passages 7a, 7b and 7c connecting the joints 2a-2c to first and second chambers 21 and 22 provided in the base portion 20. The connecting passage 7a connects the joint 2a to the second chamber 22 of the base portion 20, and the connecting passage 7c connects the joint 2c to the first chamber 21 of the base portion 20, while the connecting passage 7b connects the joint 2b to the through-hole 31b formed through the metal plate 31. The base portion 20 includes a fixing portion on a lower surface of its longitudinal end portion remote from the above-indicated connecting portion. At this fixing portion, the filter unit 2 is fixed to the reservoir unit 3. The fixing portion is parallel with the connecting portion, and is provided with the above-described two O-rings 30 and a fixing member (not shown). Two through-holes 24 and 25 are formed through the fixing portion, as shown in FIG. 5B. The upper walls of the connecting passages 7a-7c are laminar structures similar to a laminar structure consisting of a flexible film 27 and a metal sheet 28 (which will be described by reference to FIG. 3B). Namely, each of the connecting passages 7a-7c is fluid-tightly sealed at its upper opening by the flexible film backed by the metal sheet.

The base portion 20 has an interior space which is divided into the above-indicated first and second chambers 21, 22 by a partition wall 23 that extends in the vertical direction, with the ink-jet head 1 installed in the printer 500 such that the lower surface 4a of the passage unit 4 extends in the horizontal direction. As indicated in FIG. 3B, the first and second chambers 21, 22 are arranged in the horizontal direction on the respective opposite sides of the partition wall 23. Each of the first and second chambers 21, 22 has a rectangular shape in cross section taken in a vertical plane parallel to the vertical direction of extension of the partition wall 23 and the direction of arrangement of the chambers 21, 22, as indicated in FIG. 3B. The rectangle of this cross sectional shape has a larger dimension in the vertical direction than that in the horizontal direction. One of the opposite long sides of the rectangle is defined by the partition wall 23 while the other long side is defined by the laminar structure of the flexible film 27 and metal sheet 28. The metal sheet 28 functions to prevent an excessive amount of outward flexure of the flexible film 27 and direct exertion of an external force onto the flexible film 27. It is noted that the flexible film 27 and metal sheet 28 are not shown in FIG. 3A.

The first and second chambers 21, 22 are held in communication with each other through a communication passage 23x which is formed through the partition wall 23 and which is a through-hole having a substantially circular cross sectional shape, as shown in FIG. 3A. The communication passage 23x is formed through an upper end portion of the partition wall 23 and at one of longitudinally opposite ends of the partition wall 23 which is remote from the joints 2a-2c in the horizontal direction perpendicular to the vertical direction of extension of the partition wall 23 and the direction of arrangement of the two chambers 21, 22.

As shown in FIG. 5A, the first chamber 21 is partially defined by an upper wall 21a and a lower wall 21b both extending in the horizontal direction, and two end walls 21c and 21d which are inclined with respect to the vertical direction. The first chamber 21 has an inverted trapezoidal cross sectional shape as seen in the direction of arrangement of the two chambers 21, 22, as shown in FIG. 5A. An exhaust passage 26a is formed as a bypass passage, so as to surround the opening of the communication passage 23a on the side of the first chamber 21. The exhaust passage 26a, which is defined by the filter unit 2, is isolated from the first chamber 21 by a partition wall. The laminar structure of the flexible film 27 and metal sheet 28 (shown in FIG. 3B) is disposed in opposition to the partition wall 23 in the direction of arrangement of the two chambers 21, 22. The flexible film 27 of the laminar structure is fixed to the end faces of the walls 21a-21d partially defining the first chamber 21 and the end face of the side wall partially defining the exhaust passage 26a, such that the flexible film 27 partially defines the first chamber 21 and exhaust passage 26a.

The exhaust passage 26a is held in communication at its one end with an upper end portion of a filter chamber 29 (described below) through a through-hole 23f, and at the other end with an exhaust passage 26b (described below) through a through-hole 23g. The air bubbles accumulated in the upper portion of the filter chamber 29 are exhausted through the exhaust passage 26a.

As shown in FIG. 5B, the second chamber 22 is partially defined by an upper wall 22a and a lower wall 22b both extending in the horizontal direction, and two end walls 22c and 22d which are inclined with respect to the vertical direction. The second chamber 22 includes a main space having an inverted trapezoidal cross sectional shape as seen in the direction of arrangement of the two chambers 21, 22, as shown in FIG. 5B, and further includes a passage 22e communicating with the main space. The passage 22e extends from an upper corner part of the main space adjacent to the upper portion of the end wall 22d, in the longitudinal direction of the base portion 20, and is located at a vertical position higher than that of the main space, as seen in the vertical direction. Below the passage 22e, there is formed the above-indicated filter chamber 29, with a partition wall existing between the passage 22e and the filter chamber 29. The filter chamber 29 is partially defined by the above-indicated partition wall partially defining the passage 22e, and by the end wall 22d partially defining the second chamber 22. The filter chamber 29 is further partially defined by a lower wall parallel to the partition wall partially defining the passage 22e, and by an end wall parallel to the end wall 22d. The filter chamber 29 has a parallelogram cross sectional shape as seen in the direction of arrangement of the two chambers 21, 22, as shown in FIG. 5B. This parallelogram has horizontally extending opposite parallel long sides. The shape of the filter chamber 29 is substantially identical with the shape of the filter 2f, and the size of the filter chamber 29 is larger than that of the filter 2f. The above-indicated exhaust passage 26b is formed so as to surround the second chamber 22 and the filter chamber 29. Namely, the exhaust passage 26b is partially defined by the upper wall 22a, and the inclined end wall which partially defines the filter chamber 29 and which is parallel and opposed to the end wall 22d. The laminar structure of the flexible film 27 and metal sheet 28 (shown in FIG. 3B) partially defining the second chamber 22 is also disposed in opposition to the partition wall 23 in the direction of arrangement of the two chambers 21, 22. The flexible film 27 of the laminar structure is fixed to the end faces of the walls 22a-22d partially defining the second chamber 22 and the end faces of the side walls partially defining the filter chamber 29 and exhaust passage 26b, such that the flexible film 27 partially defines the second chamber 22, filter chamber 29 and exhaust passage 26b. The exhaust passage 26b is provided to discharge the ink fed from the reservoir 33x and exhaust passage 36a, out of the ink-jet head 1, into the auxiliary tank 60, for example.

Regarding the first chamber 21 shown in FIG. 5A, an angle of inclination θ1 of the end wall 21c with respect to the lower wall 21b, and an angle of inclination θ2 of the end wall 21d with respect to the lower wall 21b are both obtuse angles (e.g. about 140 degrees), while an angle of inclination θ3 of the end wall 21c with respect to the upper wall 21a, and an angle of inclination θ4 of the end wall 21d with respect to the upper wall 21a are both are both acute angles (e.g. about 40 degrees). Regarding the second chamber 22 shown in FIG. 5B, an angle of inclination θ5 of the end wall 22c with respect to the lower wall 22b, and an angle of inclination θ6 of the end wall 22d with respect to the lower wall 22b are both obtuse angles (e.g. about 140 degrees), while an angle of inclination θ7 of the end wall 22c with respect to the upper wall 22a, and an angle of inclination θ8 of the end wall 22d with respect to the upper wall 22a are both acute angles (e.g. about 40 degrees).

The obtuse angles of inclination θ1, θ2, θ5, θ6 of the end walls 21c, 21d, 22c, 22d with respect to the lower walls 21b, 22b permit smooth substantially horizontal flows of the ink through the first and second chambers 21, 22 in the longitudinal direction, without dwelling of the ink in the lower corner portions of the chambers 21, 22, and also permit smooth substantially horizontal flows of the air bubbles together with the ink, without dwelling of the air bubbles within the chambers 21, 22.

The first chamber 21 has an inlet opening 21x formed at its longitudinal end which is nearer to the joints 2a-2c (in the connecting portion of the filter unit 2), that is, remote from the communication passage 23x, as shown in FIG. 5A. Through this inlet opening 21x, the first chamber 21 is held in communication with the connecting passage 7c (shown in FIG. 3A). The upper wall 21a provides a recessed portion 21y within the first chamber 21, as also shown in FIG. 5A. The recessed portion 21y is defined by a part of the lower surface of the upper wall 21a, which part is adjacent to the inlet opening 21x and slightly offset in the upward direction from the other part of the above-indicated lower surface. The recessed portion 21y is formed so as to extend from the inlet opening 21x in the horizontal direction within the first chamber 21. The recessed portion 21y functions to temporarily capture the air bubbles contained in the ink which has entered into the first chamber 21 through the inlet opening 21x, so that the air bubbles are prevented from flowing toward the filter 2f.

The above-indicated main space of the second chamber 22 has an inlet opening 22x formed at its longitudinal end which is nearer to the joints 2a-2c (in the connecting portion of the filter unit 2), that is, remote from the communication passage 23x, as shown in FIG. 5B. Through this inlet opening 22x, the main space is held in communication with the connecting passage 7a (shown in FIG. 3A). As also shown in FIG. 5B, the main space of the second chamber 22 is held in communication with the above-indicated passage 22e, at its upper end and at its longitudinal end remote from the inlet opening 22x. At the end of the passage 22e remote from the main space, the passage 22e is held in communication with the communication passage 23x.

The partition wall 23 which partially defines the filter chamber 29 has an opening formed therethrough, at which the filter 2f is disposed in the filter chamber 29 such that the filter 2f is fixed at its peripheral portion to a portion of the partition wall 23 which defines the opening. The filter 2f is a meshed planar member configured to capture the foreign matters in the ink, and is fixed so as to extend in the vertical direction parallel to the surfaces of the partition wall 23. Thus, it will be understood that the first chamber 21 and the filter chamber 29 cooperate to define a filter accommodating space in which the filter 2f is disposed, and are held in communication with each other through the mesh of the planar filter 2f. The filter accommodating space is divided by the partition wall 23 into the first chamber 21 serving as an upstream portion, and the filter chamber 29 serving as a downstream portion. The filter chamber 29 is held in communication with the through-hole 31a of the reservoir unit 3 through the above-described through-hole 24 formed through the above-described fixing portion (lower wall) of the base portion 20, as shown in FIG. 5C.

In the filter chamber 29, the filter 2f is positioned to be nearer to the lower wall 21b than to the upper wall 21a, in the vertical direction, so that an upper gap between the upper end of the filter 2f and the upper wall 21a is larger than a lower gap between the lower end of the filter 2f and the lower wall 21b. The larger upper gap prevents the filter 2f to capture and hold the air bubbles which have entered into the first chamber 21. The communication passage 23x is located between the upper wall 21a and the filter 2f in the vertical direction, and is lightly spaced from the filter 2f in the longitudinal direction of the base portion 20 away from the inlet openings 21x, 22x.

The exhaust passage 26b has an opening 26x at its end nearer to the connecting end (nearer to the joints 2a-2c). Through this opening 26x, the exhaust passage 26b is held in communication with the connecting passage 7b (FIG. 3A). The base portion 20 has the above-described through-hole 25 through which the exhaust passage 26b is held in communication with the through-hole 31b of the reservoir unit 3.

The partition wall 23 which has the opening at which the filter 2f is fixed at its periphery, and the communication passage 23x, further has a through-hole 23f formed at an upper corner of the filter chamber 29, and a through-hole 23g communicating with the exhaust passage 26b. The filter chamber 29 is held in communication with the exhaust passage 26a through the through-hole 23f, while the exhaust passage 26a is held in communication with the exhaust passage 26b through the through-hole 23g.

Referring to FIGS. 5A-5C, the ink flows during the printing operation of the inkjet head 1 will be described.

During the printing operation of the ink-jet head 1, the valve connected to the elastic tube 62 connecting the inlet join 2c and the auxiliary tank 60 is opened, and the ink is delivered from the auxiliary tank 60 (FIG. 2) into the filter unit 2 through the joint 2c and connecting passage 7c, as indicated by arrows in FIG. 5A. At this time, the pump 53 is held at rest, while the valve connected to the elastic tube 51 connecting the joint 2a and the pump 53 and the valve connected to the elastic tube 61 connecting the joint 2b and the auxiliary tank 60 are both held in the closed state. Described in detail, the ink flows from the joint 2c into the first chamber 21 through the connecting passage 7c (FIG. 3A) and the inlet opening 21x, and then flows through the first chamber 21 toward the filter 2f, as shown in FIG. 5A. The ink then flows from the first chamber 21 into the fitter chamber 29 through the filter 2f, as shown in FIG. 5B, and enters into the reservoir unit 3 through the through-hole 24 (formed through the fixing portion of the base portion 20) and the through-hole 31a, as shown in FIG. 5C. The ink which has flown into the reservoir unit 3 through the through-hole 31a flows into the reservoir 33x through the through-hole 32a, and into the individual branch passages of the reservoir 33x. Subsequently, the ink flows into the passage unit 4 through the through-holes 34x and through-holes 4x (FIG. 4). The ink which has entered into the passage unit 4 through the through-holes 4x is distributed into the individual ink passages through the main manifold passages 41 and auxiliary manifold massages 41a, and is ejected from selected ones of the ink-ejecting nozzles according to the operations of the actuator units 5 as well known in the art. The consumption of the ink due to the ink ejections from the ink-ejecting nozzles during the printing operation causes an increase of the negative pressure at the meniscus of each ink-ejecting nozzle, and induces an ink flow from the auxiliary manifold passage 41a toward the ink-ejecting nozzle. Thus, the flows of the ink are naturally caused as the ink is consumed during the printing operation of the ink-jet head 1 to form the images on the paper sheets P.

As shown in FIG. 4, the through-holes 4x formed in the passage unit 4 are covered by respective second filters in the form of filters 4f. That is, the through-holes 34x and the through-holes 4x are held in communication with each other through these filters, so that the ink flows from the reservoir unit 3 into the passage unit 4 through the filters 4f.

Referring next to FIGS. 6A-6C, the ink flows during the nozzle purging operation of the ink-jet head 1 will be described. The nozzle purging operation is performed to forcibly introduce the ink into the passage unit 4 and eject the ink from the ink-ejecting nozzles, for the purpose of eliminating or preventing plugging of the nozzles with the ink. In other words, the nozzle purging operation is performed to discharge the ink having a relatively high degree of viscosity, from the nozzles, for thereby recovering the ink ejecting performance of the nozzles.

During the nozzle purging operation of the ink-jet head 1, the valve connected to the elastic tube 51 connecting the joint 2a and the pump 53 is opened, and the ink is delivered from the auxiliary tank 60 (FIG. 2) into the filter unit 2 through the joint 2a and connecting passage 7a, by an operation of the pump 53, as indicated by thick solid-line arrows in FIG. 6A. At this time, the valves connected to the elastic tubes 61, 62 respectively connecting the joints 2b, 2c to the auxiliary tank 60 are both held in the closed state. Described in detail, the ink flows from the joint 2a into the main space of the second chamber 22 through the connecting passage 7a (FIG. 3A) and the inlet opening 22x, and then flows through the main space and the passage 22e. Then, the ink flows from the passage 22e into the first chamber 21 through the communication passage 23x, as shown in FIG. 6B. The ink which has entered into the first chamber 21 through the communication passage 23x flows into the filter chamber 29 through the filter 2f, and then into the reservoir unit 3 through the through-hole 24 and through-hole 31a, as shown in FIG. 6C. The ink then flows from the reservoir unit 3 into the passage unit 4, and is ejected from the nozzles, as described above with respect to the printing operation of the ink-jet head 1.

The passages through which the ink flows during the nozzle purging operation from an inlet opening in the form of an opening 2a1 of the joint 2a to the ink-ejecting nozzles open in the lower surface of the passage unit 4, will be collectively referred to as a forward passage system F indicated by thick solid-line arrows in FIGS. 6A-6C. The forward passage system F is defined by the filer unit 2, reservoir unit 3 and passage unit 4. In this forward passage system F, the filter 2f and the filters 4f (FIG. 4) are disposed in series with each other, at respective upstream and downstream positions as seen in the direction of flow of the ink indicated by the thick solid-line arrows in FIGS. 6A-6C.

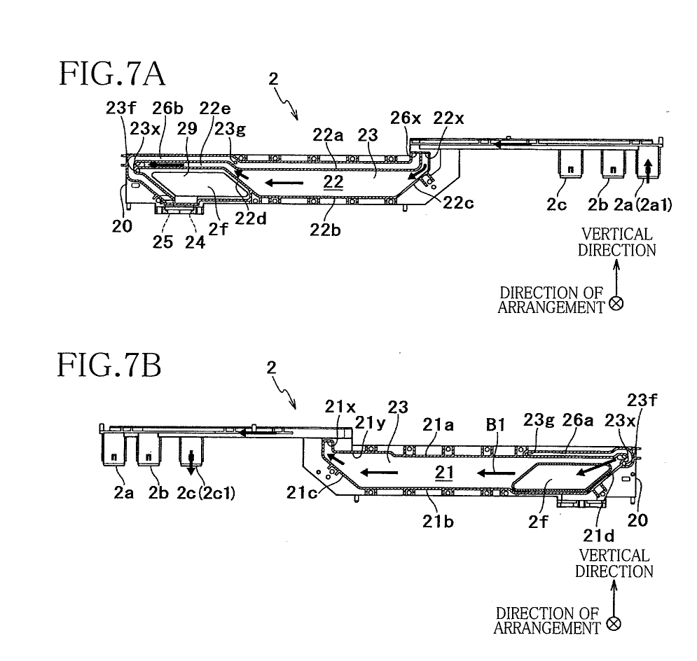

Referring next to FIGS. 7A and 7B, the ink flows during the circulation purging operation of the ink-jet head 1 will be described. The circulation purging operation is performed to forcibly introduce the ink into the filter unit 2 and remove the foreign matters deposited on the filter 2f, together with the ink, for the purpose of eliminating or preventing clogging of the filter 2f with the foreign matters. In other words, the circulation purging operation is performed to effectively discharge, out of the ink-jet head 1, air bubbles and other foreign matters accumulated in a portion of the filter unit 2 upstream of the filter 2f.

During the circulation purging operation of the ink-jet head 1, the valve connected to the elastic tube 51 connecting the joint 2a and the pump 53 is opened, and the ink is delivered from the auxiliary tank 60 (FIG. 2) into the filter unit 2 through the joint 2a and connecting passage 7a, that is, into the second chamber 22, by an operation of the pump 43, as indicated by thick solid-line arrows in FIG. 7A, and as described above with respect to the nozzle purging operation by reference to FIG. 6A. At this time, the valve connected to the elastic tube 61 connecting the joint 2b and the auxiliary tank 60 is held in the closed state while the valve connected to the elastic tube 62 connecting the joint 2c and the auxiliary tank 60 is held in the open state. The ink which has been delivered into the second chamber 22 flows into the first chamber 21 through the passage 22e and communication passage 23x, as in the nozzle purging operation. Then, the ink flows along the surface of the filter 2f to the inlet opening 21x, as indicated by the thick solid-line arrows in FIG. 7B. The ink then flows through the inlet opening 21x and connecting passage 7c (FIG. 3A) into the auxiliary tank 60 through the inlet opening 2c.

The passages through which the ink flows during the circulation purging operation from the surface of the filter 2f (from one of the opposite surfaces of the filter 2f which is exposed to the first chamber 21 and on the upstream side as seen in the direction of flow of the ink through the forward passage system F indicated in FIGS. 6A and 6B) to a first outlet opening in the form of an opening 2c1 of the joint 2c, will be collectively referred to as a first return passage system B1, as indicated by thick solid-line arrows in FIG. 7B. The first return passage system B1 is defined by the filter unit 2.

Then, the ink flows during the inter-filter purging operation of the ink-jet head 1 will be described by reference to FIGS. 8A-8C. The inter-filter purging operation is performed to forcibly introduce the ink into the filter unit 2 and reservoir unit 3, for the purpose of removing the foreign matters accumulated in the passages between the filter 2f of the filter unit 2 and the filters 4f covering the through-holes 4x open in the upper surface 4b (FIG. 4) of the passage unit 4, such that the foreign matters are discharged together with the ink from the ink-jet head 1.

During the inter-filter purging operation of the ink-jet head 1, the valve connected to the elastic tube 51 connecting the joint 2a and the pump 53 is opened, and the ink is delivered from the auxiliary tank 60 (FIG. 2) into the second chamber 22 of the filter unit 2 through the joint 2a and connecting passage 7a, by an operation of the pump 53, as indicated by thick solid-line arrows in FIG. 8A, and as described above with respect to the nozzle purging operation by reference to FIG. 6A. At this time, the valve connected to the elastic tube 62 connecting the joint 2c and the auxiliary tank 60 is held in the closed state while the valve connected to the elastic tube 61 connecting the joint 2b and the auxiliary tank 60 is held in the open state. The ink which has been delivered into the second chamber 22 flows into the first chamber 21 through the passage 22e and communication passage 23x, as indicated by thick solid-line arrow in FIG. 8B, and as described above with respect to the nozzle purging operation by reference to FIG. 6B. Then, the ink flows through the filter 2f into the filter chamber 29, as indicated by broken-line arrow in FIG. 8B, as in the nozzle purging operation. The ink flows from the filter chamber 29 into the reservoir unit 3 through the through-hole 24 (formed through the fixing portion of the base portion 20), as indicated by thick solid-line arrows in FIG. 8C. The ink which has flown into the reservoir unit 3 through the through-hole 31a flows into the reservoir 33x through the through-hole 32a, and into the individual branch passages of the reservoir 33x. Subsequently, the ink flows toward the filters 4f provided on the upper surface 4b of the passage unit 4.

Then, the ink flows upwards through the through-holes 34x away from the filters 4f on the upper surface 4b, and flows through the through-holes 32b in the end portions of the branch passages of the reservoir 33x, into the recess 32x from which the ink flows into the exhaust passage 26b through the through-hole 31b and through-hole 25, as indicated by white-line arrows in FIG. 8C. The ink which has flown into the exhaust passage 26b flows into the connecting passage 7b (FIG. 3A) through the opening 26x, as indicated by white-line arrows in FIG. 8A, and returns back to the auxiliary tank 60 (FIG. 2) through the joint 2b.

The passages through which the ink flows during the inter-filter purging operation from the upper surfaces of the filters 4f (upstream-side surfaces as seen in the direction of flow of the ink through the forward passage system F indicated in FIGS. 6A-6C) to a second outlet opening in the form of an opening 2b1 of the joint 2b, will be collectively referred to as a second return passage system B2, as indicated by the white-line arrows in FIGS. 8A and 8C. The second return passage system B2 is defined by the filter unit 2 and the reservoir unit 3.

A portion of the ink which has flown into the filter chamber 29 during the inter-purging operation flows into the exhaust passage 26a through the through-hole 23f, and into an intermediate portion of the exhaust passage 26b (FIG. 8A) through the through-hole 23g, as indicated by hatched-like arrow in FIG. 8C. The ink which has entered into the exhausts passage 26b flows into the connecting passage 7b (FIG. 3A) through the opening 26x, and returns to the auxiliary tank 60 (FIG. 2) through the joint 2b, as described above. When air bubbles exist in the filter chamber 29, the air bubbles are discharged into the auxiliary tank 60, together with the ink flowing into the exhaust passage 26a.

Each of the ink-jet heads 1 is controlled by the controller 501 (FIG. 1) of the printer 500 to perform the above-described printing operation, nozzle purging operation, circulation purging operation and inter-filter purging operation. In the present printer 500, the purging operations of each ink-jet head 1 are performed at a predetermined regular interval, or upon a predetermined manual operation by the user of the printer 500.

In the ink-jet head 1 constructed as described above according to the illustrated embodiment, the first filter 2f and the second filters 4f are disposed in series with each other in the forward passage system F such that the first filter 2f is located upstream of the second filters 4f as seen in the direction of flow of the ink through the forward passage system F, so that the foreign matters existing in the forward passage system F can be effectively captured by the first and second filters 2f, 4f. Further, the first return passage system B1 (indicated by the thick solid-line arrows in FIG. 7B) is provided for the first filter 2f, while the second return passage system B2 (indicated by the white-line arrows in FIGS. 8A and 8C) is provided for the second filters 4f, such that the first and second return passage systems B1, B2 are independent of each other. Accordingly, the foreign matters deposited on the first and second filters 2f, 4f can be effectively discharged through the respective first and second return passage systems B1, B2, by the circulation purging operation described above by reference to FIGS. 7A and 7B, and the inter-filter purging operation described above by reference to FIGS. 8A-8C. Consequently, the amount of the ink required to discharge the foreign matters can be effectively reduced.

In addition, the bypass passage in the form of the exhaust passage 26a is provided for communication between the second return passage system B2 (indicated by the white-line arrows in FIGS. 8A and 80), and a partial passage F1 (indicated by the thick solid-line arrows in FIG. 6C) which is a part of the forward passage system F between the first filter 2f and the second filters 4f. This bypass passage 26a permits a reduction in the flow resistance of the partial passage F1, making it possible to reduce a risk of destruction of the meniscus at the liquid-droplet ejecting nozzles even when the inter-filter purging operation of the liquid ejecting head is performed at a relatively high pressure of the ink, to discharge the foreign matters from the partial passage F1 between the first and second filters 2f, 4f.

If the number of the ink-ejecting nozzles is increased to permit the printing operation of the ink-jet head 1 at an increased speed, the passages formed in the ink-jet head 1 in communication with the nozzles tend to have a comparatively small diameter and a comparatively large length, and consequently have a comparatively high ink flow resistance, which requires a comparatively high ink pressure (e.g., 100 kPa) to perform the nozzle purging operation. The use of a pump having a flow-rate capacity high enough to permit the high-pressure nozzle purging operation causes pressure pulsation of the ink in the passages during an operation of the high flow-rate capacity pump, resulting in a problem of destruction of the meniscus of the nozzles, during the inter-filter purging operation of the ink-jet head 1, in particular. The destruction of the meniscus of the nozzles leads to an unnecessarily large amount of ejection of the ink from the nozzles, namely, an increase in the amount of consumption of the ink, and an undesirable decrease in the purging economy of the ink-jet head 1. In view of the drawback described above, the present ink-jet head 1 is provided with the exhaust passage 26a for communication between the partial passage F1 and the exhaust passage 26b, in order to reduce a risk of the destruction of meniscus of the nozzles during the high-pressure inter-filter purging operation, making it possible to reduce the amount of consumption of the ink and increase the purging economy of the ink-jet head 1.

The exhaust passage 26a has substantially the same ink flow resistance as a main passage system which extends from the filter 2f to the positions right above the filters 4f, as indicated by the thick solid-line arrows in FIG. 8C, and extending backwards from those positions away from the filters 4f, along the second return passage B2, as indicated by the white-line arrows in FIG. 8C, to the through-hole 23g formed in the intermediate portion of the exhaust passage 26b a, namely, to a point of connection between the second return passage B2 and the exhaust passage 26a. Accordingly, the rate of flow of the ink through the exhaust passage 26a is almost equal to that through the main passage system, permitting even discharging of the foreign matters through the exhaust passage 26a and main passage system. For example, the even discharging of the foreign matters is possible through the exhaust passage 26a and main passage system, under the conditions of meniscus withstanding pressure of 4−5 kPa; nozzle purging flow rate of 7-8 ml/s; and flow resistance of about 1800 Pa/ml/s of the exhaust passage 26a and main passage system. In this case, the destruction of meniscus of the nozzles can be prevented even with the ink pressure pulsation of about 4 ml/s during the operation of the high flow-rate capacity pump.

The filters 4f are provided for the respective through-holes 4x open in the upper surface 4b of the passage unit 4, as shown in FIG. 4, and are disposed in parallel with each other in the forward passage system F (shown in FIGS. 6A-6C). As shown in FIG. 6C, the partial passage F1 includes a main forward passage F1M extending from the back surface of the filter 2f (which is exposed to the filter chamber 29 and which is on the downstream side as seen in the above-indicated direction of flow of the liquid through the forward passage system F), and a plurality of branch forward passages F1D branching from the main forward passage F1M toward the respective filters 4f. As shown in FIGS. 8A and 8C, the second return passage system B2 includes a main return passage B2M communicating with the second outlet opening 2b1, and a plurality of branch return passages B2D which branch from the main return passage B2M toward the respective filters 4f and each of which communicates at one of opposite ends thereof with a corresponding one of the plurality of branch forward passages F1D through the through-holes 32b. This arrangement permits effective discharging of the foreign matters from the partial passage F1 between the first filer 2f and the second filters 4f, during the inter-filter purging operation of the ink-jet head 1.

The main forward passage F1M extends in the vertical direction, as shown in FIG. 6C. Accordingly, the foreign matters existing in the main forward passage F1M and the branch forward passages F1D move upwards through the main forward passage F1M due to a force of floating of air bubbles and gather near the back surface of the filter 2f on the downstream side, so that the thus gathering foreign matters can be easily discharged through the exhaust passage 26a during the inter-filter purging operation of the liquid ejecting head.

Each of the branch return passages B2D is held in communication at one of its opposite ends with a corresponding one of the branch forward passages F1D through the through-hole 32b, at a position opposed to a corresponding one of the second filters 4f (shown in FIG. 4) in the vertical direction, as shown in FIG. 8C. Namely, the point of communication between each branch return passage B2D and the corresponding branch forward passage F1D is located right above the corresponding filter 4f, so that the foreign matters can be effectively discharged owing to the force of floating of the air bubbles.

The exhaust passage 26a is held in communication with the partial passage F1, at a portion of the partial passage F1 which is near the back surface of the filter 2f on the downstream side, as shown in FIGS. 8A-8C. In the present embodiment, the exhaust passage 26a is held in communication with the filter chamber 29 through the through-hole 23f. The foreign matters existing in the exhaust passage 26a between the filters 2f, 4f tend to gather near the above-indicated surface of the filter 21. Accordingly, the communication of the exhaust passage 26a with the partial passage F1 at its above-indicated portion of the partial passage F1 permits effective discharging of the foreign matters from the partial passage F1 between the filters 2f, 4f.

The exhaust passage 26a has an air-bubble accommodating space 26a1 for temporarily accommodating air bubbles contained in the ink, as shown in FIG. 8B. This air-bubble accommodating space 26a1 is located above the above-indicated portion of the partial passage F1. The exhaust passage 26a extends in the horizontal direction above the through-hole 23f, and one end portion of the exhaust passage 26a is curved upwardly so as to form the air-bubble accommodating space 26a1, which has a higher position than the other portion of the exhaust passage 26a, for temporarily accommodating the air bubbles. In this arrangement, a risk of destruction of the meniscus of the ink-ejecting nozzles can be reduced owing to a damping effect of the air bubbles accommodated in the air-bubble accommodating space 26a1, even when the inter-filter purging operation of the ink-jet head 1 is performed at a high ink pressure. The air bubbles existing in the filter chamber 29 gather together in an upper portion of the filter chamber 29 due to a floating force of the air bubbles, when the ink-ejecting surface 4a faces downwards. The through-hole 23f open to an upper corner of the filter chamber 29 permits almost all of the air bubbles to move from the filter chamber 29 into the air-bubble accommodating space 26a1. Thus, the air bubbles are unlikely to remain in the filter chamber 29, so that the air bubbles do not move toward the ink-ejecting nozzles during at least the printing operation of the ink-jet head 1.

The filter 2f is disposed so as to extend in the vertical direction, in parallel with the partition wall 23, so that the surface area of the filter 2f can be increased to improve its function of capturing the foreign matters, without a considerable increase in the size of the ink-jet head 1 in the horizontal direction. Further, the foreign matters are likely to gather in an upper portion of the filter accommodating space (consisting of the first chamber 21 and the filter chamber 29), owing to a force of floating of the air bubbles contained in the ink in the filter accommodating space 21, 29, so that the foreign matters can be efficiently discharged from the filter accommodating space 21, 29, owing to the vertical extension of the filter 2f and the force of floating of the air bubbles. In addition, unlike the horizontal extension of the filter 2f, the vertical extension is effective to prevent clogging of the filter 2f with the foreign matters.

The filter 2f is located below the upper wall 22a (more precisely, the wall between the filter chamber 29 and the passage 22e) such that a gap space is left in the vertical direction between the filter 2f and the upper wall 22a, as shown in FIG. 8A. In this arrangement, the foreign matters existing in the filter chamber 29 are likely to gather in an upper part of the filter chamber 29, that is, in the gap space above the filter 2f, owing to a force of floating of air bubbles, as indicated by a hatched-line arrow in FIG. 8A, so that the foreign matters can be efficiently discharged from the filter chamber 29, and are unlikely to remain on the filter 2f, that is, unlikely to clog the filter 2f.

The filter chamber 29 is held in communication with the exhaust passage 26a through the through-hole 23f formed between the filter 2f and the upper wall 22a in the vertical direction, as shown in FIGS. 8A and 8B, so that the foreign matters are moved from the filter chamber 29 into the exhaust passage 26a through the through-hole 23f, owing to a force of floating of air bubbles contained in the ink in the filter chamber 29, whereby the foreign matters can be effectively discharged from the filter chamber 29.

The filter accommodating space consisting of the first chamber 21 and the filter chamber 29 is partially defined by the flexible films 27 opposed to the partition wall 23 and the filter 2f in the horizontal direction. In this arrangement, the filter accommodating space functions as a pressure damper which effectively prevents destruction of the meniscus of the ink-ejecting nozzles. Since the flexible films 27 are disposed so as to extend in the vertical direction, the surface area of the flexible films 27 can be increased to improve their damping effect, without a considerable increase in the size of the ink-jet head 1 in the horizontal direction.

While the preferred embodiment of the present invention has been described above by reference to the drawings, for illustrative purpose only, it is to be understood that the present invention is not limited to the details of the illustrated embodiment, but may be embodied with various changes and modifications, which may occur to those skilled in the art, without departing from the spirit and scope of the invention defined in the appended claims.

In the illustrated embodiment, the filter 2f is accommodated in a space in the form of the first and second chambers 21, 22 each of which is partially defined by the laminar structure consisting of the flexible film 27 and the metal sheet 28, as shown in FIG. 3B. However, the laminar structure may be replaced by the flexible film 27 or any other member.

The shapes and positions of the filters 2f, 4f are not limited to those in the illustrated embodiment. For example, the filter 2f may have any shape other than the parallelogram shape as seen in the direction of arrangement of the two chambers 21, 22. Further, the filter 2f disposed below the upper wall 21a in the illustrated embodiment may be disposed in contact with the upper wall 21a, and the filters 4f having a circular shape in the illustrated embodiment may have any other shape corresponding to that of the through-holes 4x.

Although the partition wall. 23 and filter 2f of the ink-jet head 1 according to the illustrated embodiment are disposed so as to extend in the vertical direction, the partition wall and filter may be disposed so as to extend in any direction which intersects the horizontal direction and which is inclined with respect to the vertical direction. The filter 2f may be disposed so as to extend in the horizontal direction.

In the illustrated embodiment, the first filter in the form of the filter 2f is accommodated in the filter unit 2 such that the filter 2f is disposed so as to extend in the vertical direction. However, the ink-jet head 1 need not include the filter unit 2, provided the first filter is disposed in a suitably shaped portion of the forward passage system which is upstream of the second filter, such that the first filter is disposed so as to extend in a direction intersecting the direction of flow of the liquid through the forward passage system F.

The main forward passage F1M need not extend in the vertical direction, but may extend in any direction intersecting the vertical direction.

In the illustrated embodiments, the positions of communication between the branch return passages B2D and the branch forward passages F1D are opposed to the respective filters 4f in the vertical direction. However, the positions of communication need not be opposed to the filters 4f in the vertical direction.

Although the plurality of second filters 4f are disposed in the forward passage system F, in parallel with each other, in the illustrated embodiment, only one second filter may be disposed. In this case, the forward passage system F need not include the main forward passage F1M and the branch forward passages F1D, and the second return passage system B2 need not include the main return passage B2M and the branch return passages B2D.

The shapes and sizes of the forward passage system F, first return passage system B1, second return passage system B2 and bypass passages 26a, 26b are not limited to those in the illustrated embodiment. For instance, the bypass passages may be configured so as not to include a space in which the air bubbles are accumulated.

The bypass passages 26a, 26b may be connected to the partial passage F1M and second return passage system B2, at any desired positions. In the illustrated embodiment, the bypass passages have substantially the same value of flow resistance as the forward passage system F and first and second return passage systems B1, B2. However, the bypass passages may have any flow resistance value. Further, the bypass passages may be eliminated.

While the first and second return passage systems B1, B2 are completely independent from each other in the illustrated embodiment, the two return passage systems B1, B2 may have at least one common portion.

The liquid ejecting head according to the present invention may be of either a line printing type or a serial printing type, and may be used in an apparatus other than the printer, for example, in a facsimile or copying apparatus. The liquid ejecting head of the invention may use a liquid other than an ink.

Although the ink-jet head 1 according to the illustrated embodiment of this invention uses the piezoelectric actuator units 5 configured to eject the liquid from the nozzles, the ink-jet head may use other types of actuator such as an electrostatic type and a resistor-heating thermal type.

What is claimed is:

1. A liquid ejecting head comprising:
a forward passage system extending from an inlet opening to which a liquid is supplied from a liquid supply source to a plurality of liquid-droplet ejecting nozzles;
a first filter and at least one second filter disposed in series with each other in the forward passage system to capture foreign matters contained in the liquid, such that the first filter is located upstream of the at least one second filer as seen in a direction of flow of the liquid through the forward passage system;
a first return passage system extending from one of opposite surfaces of the first filter which is on an upstream side as seen in said direction of flow of the liquid, to a first outlet opening from which the liquid is discharged and which is different from the inlet opening; and
a second return passage system extending from one of opposite surfaces of the at least one second filter which is on an upstream side as seen in said direction of flow of the liquid, to a second outlet opening from which the liquid is discharged and which is different from the first outlet opening.

2. The liquid ejecting head according to claim 1, further comprising a bypass passage for communication between the second return passage system, and a partial passage which is a part of the forward passage system between the first filter and the at least one second filter.

3. The liquid ejecting head according to claim 2, wherein the at least one second filter consists of a plurality of second filters disposed in parallel with each other in the forward passage system, and the partial passage includes a main forward passage extending from the other of the opposite surfaces of the first filter which is on a downstream side as seen in said direction of flow of the liquid, and a plurality of branch forward passages branching from the main forward passage toward the respective second filters,
and wherein the second return passage system includes a main return passage communicating with the second outlet opening, and a plurality of branch return passages which branch from the main return passage toward the respective second filters and each of which communicates at one of opposite ends thereof with a corresponding one of the plurality of branch forward passages.

4. The liquid ejecting head according to claim 3, wherein the main forward passage extends in a vertical direction when droplets of the liquid are ejected downwards in the vertical direction from the liquid-droplet ejecting nozzles.

5. The liquid ejecting head according to claim 3, wherein each of the branch return passages is held in communication at one of opposite ends thereof with a corresponding one of the branch forward passages, at a position opposed to a corresponding one of the second filters in a vertical direction when droplets of the liquid are ejected downwards in the vertical direction from the liquid-droplet ejecting nozzles.

6. The liquid ejecting head according to claim 2, wherein the bypass passage is held in communication with the partial passage, at a portion of the partial passage which is near the other of the opposite surfaces of the first filter.

7. The liquid ejecting head according to claim 6, wherein the bypass passage has an air-bubble accommodating space for temporarily accommodating air bubbles contained in the liquid, the air-bubble accommodating space being located above said portion of the partial passage when droplets of the liquid are ejected downwards in the vertical direction from the liquid-droplet ejecting nozzles.

8. The liquid ejecting head according to claim 1, wherein the forward passage system includes a filter accommodating space in which the first filter is disposed and which is partially defined by a planar partition wall to which the first filter is fixed and which extends in a vertical direction when droplets of the liquid are ejected downwards in the vertical direction from the liquid-droplet ejecting nozzles,
and wherein the filter accommodating space includes an upstream portion and a downstream portion which are arranged in a horizontal direction such that the filter accommodating space is divided by the planar partition wall into the upstream and downstream portions and such that the upstream portion is located upstream of the downstream portion as seen in said direction of flow of the liquid.

9. The liquid ejecting head according to claim 8, wherein the downstream portion is partially defined by an upper wall, and the first filter is located below the upper wall such that a gap space is left in the vertical direction between the first filter and the upper wall when the droplets of the liquid are ejected downwards in the vertical direction from the liquid-droplet ejecting nozzles.

10. The liquid ejecting head according to claim 9, further comprising: a bypass passage for communication between the second return passage system, and a partial passage which is a part of the forward passage system between the first filter and the at least one second filter; and a through-hole formed between the first filter and the upper wall in the vertical direction when the droplets of the liquid are ejected downwards in the vertical direction from the liquid-droplet ejecting nozzles, and wherein the downstream portion is held in communication with the bypass passage through the through-hole.

11. The liquid ejecting head according to claim 8, wherein the filter accommodating space is partially defined by a flexible film opposed to the planar partition wall and the first filter in the horizontal direction.
